(19) United States
(12) Patent Application Publication
(10) Pub. No.: US 2011/0281546 A1
(43) Pub. Date: Nov. 17, 2011

(54) System And Method For Making A Call

(76) Inventor: Alexander V. Libkind, (US)

(21) Appl. No.: 13/101,037

(22) Filed: May 4, 2011

Related U.S. Application Data
(60) Provisional application No. 61/334,112, filed on May 12, 2010.

(51) Int. Cl. H04M 11/04

(52) U.S. Cl. 455/404.1

(57) ABSTRACT

This application describes a method and system for converting an emergency non-voice communication to a voice communication for transmission to a public safety answering point.

### CROSS REFERENCE TO RELATED APPLICATIONS

This application claims the benefit of priority under 35 U.S.C. §119 to U.S. Provisional Patent Application Ser. No. 61/334,112, filed on May 12, 2010, entitled, “SYSTEM AND METHOD FOR MAKING A CALL”, the entire disclosures of which is incorporated by reference herein.

### FIELD OF THE INVENTION

This application relates to a system and method for making a call using a text message from a cellular telephone.

### BACKGROUND

In some emergency situations a voice call is inappropriate or even ill advised. However, due to the current limitations of the Emergency 911 Service such as Enhanced 911, a non-voice call will not be answered. SMS or text messaging has become one of the most dominant person to person communications methods in the US and the world. However, if an individual sends a text message to 911, the message will not reach its intended recipient. There are documented cases where individuals where texting 911 in a situation where a voice call would have been dangerous, but these texts went into the ether because the individuals did not know that texting 911 does not work. For example, during the Virginia University shooting tragedy, students were hiding under desks and sending valuable information via text message to 911. Unfortunately these messages never reached their intended destination.

Next Generation 911 is designed to solve some of these problems, but it is not only expensive, but also requires a significant capital investment. This invention helps to deal with the current problem of lost 911 text and other emergency electronic messages. Thus, there is a need for a system for sending these messages to public safety answering points (PSAPs), like 911 systems, in a manner in which emergency assistance will be provided.

### SUMMARY OF THE INVENTION

The invention provides a method of providing information from a subject to a public safety answering point (PSAP) comprising generating a non-voice electronic communication (NVEC) from the subject; designating the appropriate PSAP for the communication to be sent to; transforming the NVEC to a voice communication and/or connecting it to a Call Center; and sending the voice communication to the appropriate PSAP. In one embodiment of the method of the invention, the NVEC further comprises information regarding the location of the generator of the NVEC.

In another embodiment of the method of the invention, the location information is generated by a global positioning system. In one aspect of this embodiment, the address is generated from the global positioning system information with an automatic location identification (ALI) or a master street guide database.

In another embodiment of the method of the invention, the NVEC contains information regarding the type of emergency encountered by the generator of the non-voice electronic communication. In another embodiment of the method of the invention, the non-voice electronic communication is selected from the group consisting of a short message service (SMS) message, a multimedia messaging service (MMS) message, an instant message (IM), and an electronic mail (e-mail) message. In another embodiment of the method of the invention, the NVEC is sent from a cellular phone. In another embodiment of the method of the invention, the voice communication is transferred by voice over interne protocol (VoIP).

In another embodiment of the method of the invention, the method further comprises the PSAP generating a voice communication; transforming the voice communication to a NVEC automatically or via a Call Center; and sending the NVEC to the subject.

The invention also provides a system comprising a network for receiving NVECs; an interactive voice response unit (either automatically generated by an electronic system or a person in a Call Center) that converts the NVECs to voice communication; and a communication distributing unit that sends converted voice communications to an appropriate public safety answering point (PSAP).

In one embodiment of the system of the invention, the system further comprises a non-voice electronic communication sending unit that directs its non-voice electronic communications through the network to the interactive voice response unit and the communication distributing unit. In another embodiment of the system of the invention, the NVECs further comprise information regarding the nature of an emergency. In another embodiment of the system of the invention, the NVECs further comprise information regarding the location of the sender of the non-voice electronic communications.

In another embodiment of the system of the invention, the non-voice electronic communication sending unit further comprises a geographic information system (GIS). In one aspect of this embodiment, the GIS is a global positioning system (GPS).

### BRIEF DESCRIPTION OF THE DRAWINGS

FIG. 1 is a schematic describing an embodiment of the system and method for communicating with a Call Center using a text message from a cellular telephone.

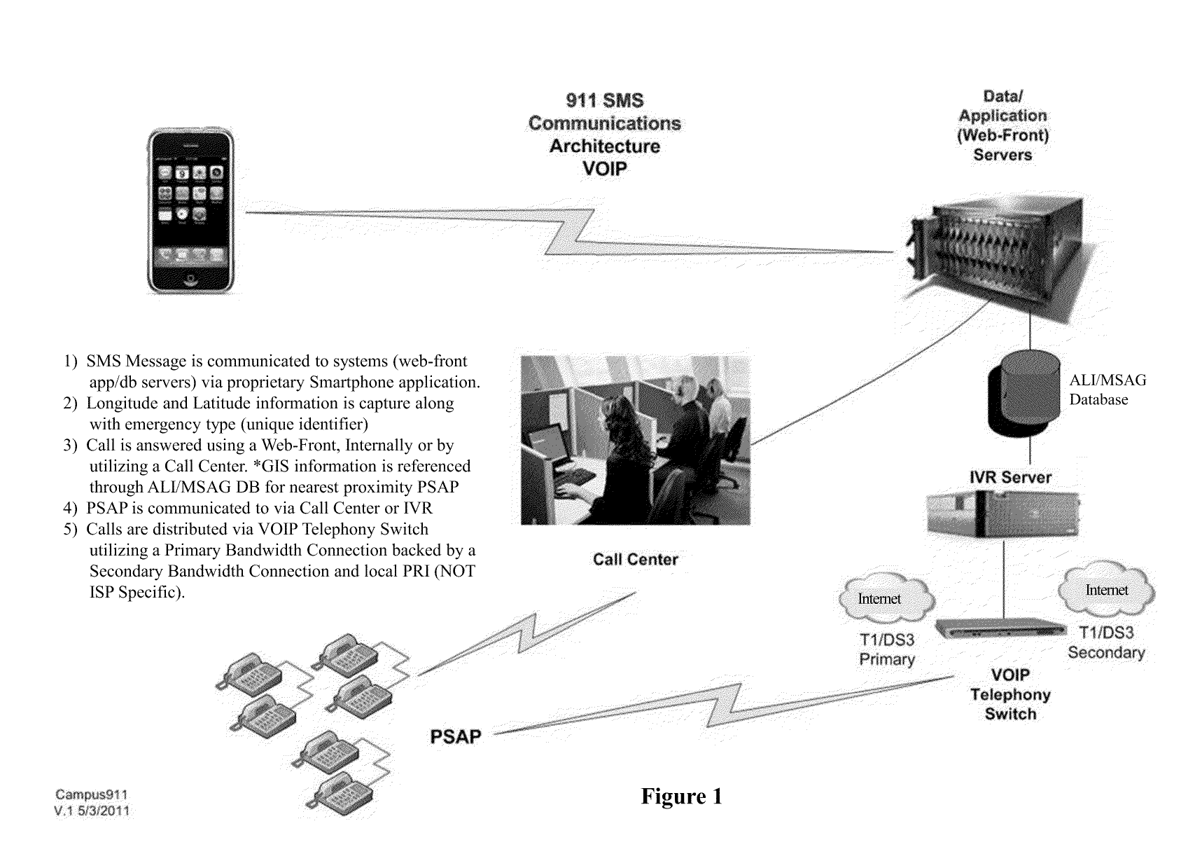

### DETAILED DESCRIPTION OF THE PREFERRED EMBODIMENTS

The invention provides methods and a system for sending an electronic communication to a public safety answering point (PSAP) so that an emergency response is generated. The electronic communication to the PSAP sent from an electronic device in control of the sender is any type of electronic communication except a voice communication. In specific embodiments of the invention, non-voice electronic communications (NVECs) include short message service (SMS) messages, a multimedia messaging service (MMS) messages, instant messages (IMs), and electronic mail (e-mail) messages.

According to the invention, NVECs are sent via a network for sending and receiving NVECs, ultimately to an interactive voice response (IVR) server and/or Call Center. When utilizing an IVR, the IVR server recognizes the message in the NVEC and converts it to a voice communication. The voice communication is then sent to a PSAP. When utilizing a Call Center, the individual at the Call Center will communicate directly to the PSAP. In certain embodiments, this is done through a voice over the Internet protocol (VoIP) telephony switch.

Information sent in the NVEC to the PSAP includes the nature of the emergency, the identity of one or more person(s) experiencing the emergency as well as the location of the one or more person(s) experiencing the emergency. In certain embodiments of the invention, the nature of the emergency is inputted into the NVEC by the one or more person(s) experiencing the emergency or a human observer. In other embodiments, the nature of the emergency is detected by a device that senses one or more traits of the one or more person(s) on whose behalf the NVEC is sent. In certain specific embodiments, the traits sensed by the electronic device include whether the one or more person(s) is standing upright, the heart rate of the one or more person(s), whether the one or more person(s) is conscious, the glucose concentration of the blood of the one or more person(s), the cholesterol, LDL, VLDL, HDL and or triglyceride level of the blood of the one or more person(s), the insulin concentration of the blood of the one or more person(s), hydration of the one or more person(s) and whether the one or more person(s) is in shock. Any of these traits of the one or more person(s) are sent by NVEC by the sending device.

In certain embodiments of the invention, the identity of the one or more person(s) experiencing the emergency is delivered in the NVEC. Either a device is pre-programmed with the identity of the one or more person(s), or the one or more person(s) or a human observer enters this information into the NVEC manually. In specific embodiments, other medical information regarding the one or more person(s) is also sent. This includes pre-existing medical conditions that the one or more person(s) may have. These include diabetes, arthrosclerosis, prior cardiac infarction, allergic reactions, Alzheimer's disease, Parkinson's disease, psychological disorders and neurological conditions. In other embodiments of the invention, additional information regarding the situation of the one or more person(s) is sent. Optionally, any activities the one or more person(s) is likely to be engaged in at the time the NVEC is sent can be relayed. These activities include hiking, camping, mountain climbing, snorkeling or SCUBA diving.

In other embodiments of the invention, the location of the one or more person(s) experiencing the emergency is sent in the NVEC. In certain embodiments, the location of the one or more person(s) is inputted into the NVEC by the one or more person(s) or by a human observer. In other embodiments, the sending device either is present with the one or more person(s) and contains a geographical information system (GIS) or the location information has already been inputted into the sending device. The device then enters this information in the NVEC.

The NVEC is transmitted from the sending device across a network. The NVEC is received by a recipient that transforms the NVEC into a voice communication. In certain embodiments, this transformation is done electronically by some form of interactive voice response (IVR) server. The IVR server transforms the information in the NVEC to a voice communication that a human operator can understand. In other embodiments, the NVEC is transformed by a human to a voice communication. For example, the NVEC could be a text message of some sort that is read and spoken to a human operator at a Call Center and then transmitted to the PSAP.

In some embodiments, after the NVEC is transformed into a voice communication, the voice message is transferred or a voice call made to the appropriate PSAP. The appropriate PSAP is chosen based on the communicated or known location of the one or more persons experiencing the emergency. The location of the one or more person(s) is communicated as explained above. In certain embodiments, the voice message is transmitted by a conventional phone line. In one specific embodiment, when the voice message is transformed by a human, the voice message is transmitted by a conventional phone line. In other embodiments, the voice message is transmitted by a voice over Internet protocol (VoIP) service. Either a human operator or a device calls the appropriate PSAP and transmits the voice message.

In specific embodiments, when GIS data is provided in the NVEC, this data is correlated with a database to provide an address for emergency response. In certain embodiments, coordinates for the position of the one or more person(s) experiencing the emergency are converted to an address by consulting a service or database. Services and databases include automatic location identification (ALI) or a master street address guide (MSAG). This address information is then transmitted to the PSAP with the rest of the information in the NVEC.

One method of acquiring GIS information of a sender is through base station or cell tower triangulation. Each base station or cell tower, for example, cell tower, measures the amount of time it takes to receive a mobile telephone's signal when it makes a wireless 911 call. This time data is translated into the distance data, estimating how far the mobile telephone is from the base station or cell tower. This distance data is then cross-referenced with distance data from at least one other base station or cell tower that received the mobile telephone's signal to arrive at longitudinal and latitudinal coordinates for that mobile telephone. Alternatively, the mobile telephone itself can triangulate its location by cross-referencing time-synchronized signals sent from multiple base stations or cell towers. The angle at which a mobile telephone's signal arrives at a base station or cell tower can also be determined using antenna arrays. This angle data can also be cross-referenced with angle data from other base stations or cell towers, and the mobile telephone's location can be triangulated. Another method of acquiring GIS information of a sender is global positioning system (GPS) receivers that can receive GPS signals from GPS satellites to determine location.

In certain embodiments, when the voice message is communicated to a human operator at a PSAP, the human operator may make voice or touch pad communications to be relayed back to the one or more persons experiencing the emergency. In specific embodiments, an IVR server is used to interpret the speech of the human operator at the PSAP. In other embodiments, the human operator is provided with a number of choices to choose between by pressing one or more numbers on the telephone. In other embodiments, the human operator is in direct voice communication with a human Call Center which is responsible for creating a response NVEC. In certain embodiments, the information request or information provided by the human operator be it directly from a PSAP or through a Call Center is then transformed into a NVEC which is transmitted back to the sending device. At this point the one or more person(s), a human observer or the sending device itself can reply with more information via NVEC. In other embodiments, the voice message generated by the human operator is sent back to the sending device as a voice message.

The invention also provides an electronic application that is installed on a sending device. The application provides an electronic interface on the sending device to relay the NVEC through the system to the Call Center or PSAP. In certain embodiments, the application allows a sender to indicate the level of emergency, to route the NVEC to the correct PSAP. In specific embodiments, the NVEC can be designated 911, 411, 311 or 711 appropriate. In other embodiments, the application provides a confirmation when the NVEC has been received at a IVR server or Call Center. In certain specific embodiments, the application requires validation of the NVEC communication. The validation can occur before the message is sent or when the message is received by the IVR server or Call Center, or any other part of the system of the invention. In certain embodiments, confirmation requires multiple button presses by the sender or the receiver or entry of a code.

In specific embodiments, the electronic NVEC sending devices of the invention includes, but are not limited to, a mobile telephone, a combination PDA and mobile telephone, a PDA, an integrated messaging device (IMD), a desktop computer, or a notebook computer. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection to a base station. The base station may be connected to a network server that allows communication between the mobile telephone network and the Internet. The system may include additional communication devices and communication devices of different types.

The NVEC sending devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. The NVEC sending devices may also communicate using various media including, but not limited to, radio, infrared, laser, cable connection, and the like.

The system of the invention provides a means for the transmission of a NVEC to a PSAP in order to create an emergency response. The system of the invention includes a means for transforming a NVEC into a voice communication. In certain embodiments, this means is electronic, for example, an IVR server. In other embodiments, the means is a human listener who creates the voice communication after reading the NVEC.

The system of the invention may comprise any combination of wired or wireless networks including, but not limited to, a mobile telephone network, a wireless Local Area Network (LAN), a Bluetooth personal area network, an Ethernet LAN, a token ring LAN, a wide area network, the Internet, i.e., voice over Internet Protocol (VoIP), etc. The system may include both wired and wireless communication devices.

In certain embodiments, the system includes a mobile telephone network and the Internet. Connectivity to the Internet may include, but is not limited to, long range wireless connections, short range wireless connections, and various wired connections including, but not limited to, telephone lines, cable lines, power lines, and the like.

In specific embodiments of the system of the invention, the system includes a VoIP device for transmission of the voice communication to the PSAP. Appropriate VoIP devices include a VoIP telephony switch. In other embodiments, a conventional phone device is used to send the transformed voice communications.

In alternative embodiments, the system includes a geographic information system (GIS) server coupled to a database which can include or store a reverse 911 database. This database is used to identify and access phone numbers in a particular or selected geographic area and is often used by governmental and other entities to contact people in an emergency.

In certain embodiments, the system of the invention also includes an electronic application, as described above, that facilitates the transmission of the NVEC to the NVEC transforming means and onto the PSAP. In certain embodiments, the application is installed on a NVEC sending device, for example, a cellular phone.

Definitions

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including definitions, will control. In addition, the materials, methods, and examples are illustrative only not intended to be limiting. Other features and advantages of the invention will be apparent from the following detailed description and claims.

While the invention has been described with reference to particularly preferred embodiments and examples, those skilled in the art recognize that various modifications may be made to the invention without departing from the spirit and scope thereof.

### EXAMPLES

### Example 1

An SMS distributed call is generated from a proprietary application installed in an SMS generating device. The SMS triggers an IVR server or Call Center which relays messages based on criticality. The SMS provides information for a three phase call distribution, emergency, non emergency or designated: i.e. 911, 411, 311, 711 etc.

The SMS is acknowledged when it has reached the IVR server or Call Center. After conversion to a voice communication, the message is then sent to the appropriate PSAP through a telephony platform. The telephony platform is VOIP based with two means of connectivity backed by a third primary rate interface (PRI) for redundancy.

The callers GIS location is captured by the proprietary application locally on the phone and is passed along for identification and tracking locations, the nearest PSAP is then generated through a database lookup and communicated to the PSAP. The proprietary application also has a two button validation process for confirmation of the validity of the message.

Database capture and IVR log records are stored for post emergency follow-up. Unique identifiers are also captured at the time of call and can be stored for repeat or erroneous call quality checks and message reminders.

What is claimed is:

1. A method of providing information from a subject to a public safety answering point (PSAP) comprising
(a) generating a non-voice electronic communication (NVEC) from the subject;
(b) designating the appropriate PSAP for the communication to be sent to;
(c) transforming the NVEC to a voice communication; and
(d) sending the voice communication to the appropriate PSAP.

2. The method of claim 2, wherein the NVEC further comprises information regarding the location of the generator of the NVEC.

3. The method of claim 2, wherein the location information is generated by a global positioning system.

4. The method of claim 3, wherein the address is generated from the global positioning system information with an automatic location identification (ALI) or a master street guide database.

5. The method of claim 1, wherein the NVEC contains information regarding the type of emergency encountered by the generator of the non-voice electronic communication.

6. The method of claim 1, wherein the non-voice electronic communication is selected from the group consisting of a short message service (SMS) message, a multimedia messaging service (MMS) message, an instant message (IM), and an electronic mail (e-mail) message.

7. The method of claim 1, wherein the NVEC is sent from a cellular phone.

8. The method of claim 1, wherein the voice communication is transferred by voice over internet protocol (VoIP).

9. The method of claim 1, further comprising
(e) the PSAP generating a voice communication;
(f) transforming the voice communication to a NVEC; and
(g) sending the NVEC to the subject.

10. A system comprising
(a) a network for receiving NVECs;
(b) a unit that converts the NVECs to voice communication; and
(c) a communication distributing unit that sends converted voice communications to an appropriate public safety answering point (PSAP).

11. The system of claim 10, wherein the system further comprises a non-voice electronic communication sending unit that directs its non-voice electronic communications through the network to the interactive voice response unit and the communication distributing unit.

12. The system of claim 10, wherein the NVECs further comprise information regarding the nature of an emergency.

13. The system of claim 10, wherein the NVECs further comprise information regarding the location of the sender of the non-voice electronic communications.

14. The system of claim 11, wherein the non-voice electronic communication sending unit further comprises a geographic information system (GIS).

15. The system of claim 14, wherein the GIS is a global positioning system (GPS).

16. The system of claim 10, wherein the unit is an interactive voice response unit or a human at a Call Center.
